(19) United States
(12) Patent Application Publication
(10) Pub. No.: US 2015/0002974 A1
(43) Pub. Date: Jan. 1, 2015

(54) PROTECTION CIRCUIT

(71) Applicants: Hong Fu Jin Precision Industry (Shenzhen) Co., Ltd., Shenzhen (CN); Hon Hai Precision Industry Co., Ltd., New Taipei (TW)

(72) Inventor: HAI-QING ZHOU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/256,489

(22) Filed: Apr. 18, 2014

(30) Foreign Application Priority Data
Jun. 28, 2013 (CN) 2013102639462

(51) Int. Cl. H02H 5/04

(52) U.S. Cl. CPC H02H 5/042; H02H 5/047
USPC 361/106

(57) ABSTRACT

A protection circuit used to protect a first metal-oxide-semiconductor field effect transistor (MOSFET) includes a control circuit and a conversion circuit. The control circuit includes a negative temperature coefficient thermistor. When a temperature of the first MOSFET is not higher than a preset value, the control circuit controls the conversion circuit to operate normally. When the temperature of the first MOSFET is higher than the preset value, the control circuit stops the operating of the first MOSFET.

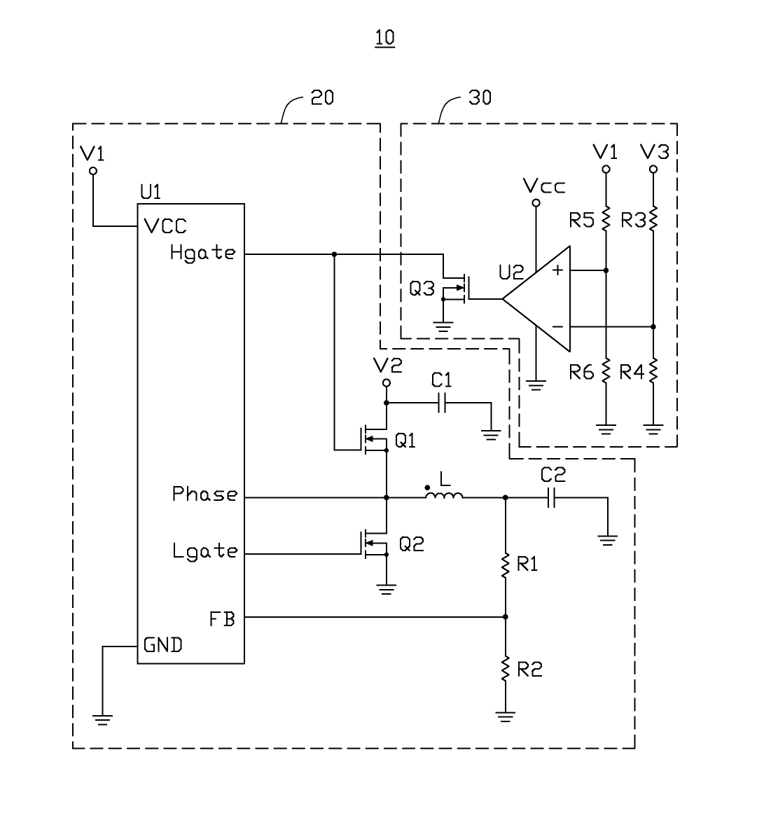

### FIELD

The present disclosure relates to a protection circuit.

### BACKGROUND

Heat is generated when a metal-oxide-semiconductor field effect transistor (MOSFET) is operating in a circuit. If a temperature of the MOSFET is higher than a breakdown temperature, the MOSFET can be punctured which may damage the circuit.

Therefore, there is room for improvement in the art.

### BRIEF DESCRIPTION OF THE DRAWING

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a circuit diagram of an embodiment of a protection circuit of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The reference “a plurality of” means “at least two.”

The FIGURE shows an embodiment of a protection circuit 10 of the present disclosure.

The protection circuit 10 comprises a conversion circuit 20 and a control circuit 30.

The conversion circuit 20 comprises a driving chip U1, a inductor L, capacitors C1 and C2, resistors R1 and R2, and n-channel metal-oxide-semiconductor field effect transistors (MOSFETs) Q1 and Q2. A power pin VCC of the driving chip U1 is connected to a power input terminal V1. A first driving pin Hgate of the driving chip U1 is connected to a gate of the MOSFET Q1. A drain of the MOSFET Q1 is connected to a second power input terminal V2. The drain of the MOSFET Q1 is also grounded through the capacitor C1. A source of the MOSFET Q1 is connected to a phase pin Phase of the driving chip U1. A second driving pin Lgate of the driving chip U1 is connected to a gate of the MOSFET Q2. A drain of the MOSFET Q2 is connected to the phase pin Phase of the driving chip U1. A source of the MOSFET Q2 is grounded. The phase pin Phase of the driving chip U1 is grounded through the inductor L, the resistors R1 and R2 in that order. A node between the inductor L and the first resistor R1 is grounded through the capacitor C2. A node between the resistors R1 and R2 is connected to a feedback pin FB of the driving chip U1.

The control circuit 30 comprises an electronic switch, such as a n-channel MOSFET Q3, resistors R3 to R6, and an operational amplifier U2. A terminal of the resistor R3 is connected to a third power input terminal V3. Another terminal of the resistor R3 is grounded through the resistor R4. A terminal of the resistor R5 is connected to the first power input terminal V1. Another terminal of the resistor R5 is grounded through the resistor R6. A non-inverting input of the operational amplifier U2 is connected to a node between the resistors R5 and R6. An inverting input of the operational amplifier U2 is connected to a node between the resistor R3 and R4. An output of the operational amplifier U2 is connected to a gate of the MOSFET Q3. A drain of the MOSFET Q3 is connected to the gate of the MOSFET Q1. A source of the MOSFET Q3 is grounded. The resistor R5 is a negative temperature coefficient thermistor and placed near the MOSFET Q1. A resistance of the resistor R5 has a negative temperature coefficient with a temperature of the MOSFET Q1. When the temperature of the MOSFET Q1 is not higher than a first preset value, the resistance of the resistor R5 is not less than a second preset value. A voltage of the non-inverting input of the operational amplifier U2 is not higher than a voltage of the inverting input of the operational amplifier U2. The operational amplifier U2 outputs a low level signal, such as logic 0. When the temperature of the MOSFET Q1 is higher than the first preset value, the resistance of the resistor R5 is less than the second preset value. The voltage of the non-inverting input of the operational amplifier U2 is higher than the voltage of the inverting input of the operational amplifier U2. The operational amplifier U2 outputs a high level signal, such as logic 1.

When the protection circuit 10 is operating, the driving chip U1 outputs pulse signals alternately through the first driving pin Hgate and the second driving pins Lgate. Thus when the MOSFET Q1 is turned on, the MOSFET Q2 is turned off. The second power input terminal V2 charges the inductor L and the capacitor C2. When the MOSFET Q1 is turned off, the MOSFET Q2 is turned on. The inductor L and the capacitor C2 discharges. When the temperature of the MOSFET Q1 is not higher than the first preset value, the operational amplifier U2 outputs a low level signal, such as logic 0. The MOSFET Q3 is turned off The conversion circuit 20 operates normally. When the temperature of the MOSFET Q1 is higher than the first preset value, the operational amplifier U2 outputs a high level signal, such as logic 1. The MOSFET Q3 is turned on. The gate of the MOSFET Q1 is grounded. The MOSFET Q1 is turned off to stop generating heat.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A protection circuit for protecting a first metal-oxide-semiconductor field effect transistor (MOSFET), comprising:
a control circuit comprising an electronic switch, first to fourth resistors, and an operational amplifier, wherein a first terminal of the first resistor is connected to a first power input terminal, a second terminal of the first resistor is grounded through the second resistor, a first terminal of the third resistor is connected to a second power input terminal, a second terminal of the third resistor is grounded through the fourth resistor, a non-inverting input of the operational amplifier is connected to a node between the third resistor and the fourth resistor, an inverting input of the operational amplifier is connected to a node between the first resistor and the second resistor, the electronic switch has first to third terminals, the first terminal of the electronic switch is connected to an output of the operational amplifier, the second terminal of the electronic switch is connected to a gate of the first MOSFET, the third terminal of the electronic switch is grounded, the third resistor is a thermistor placed near the first MOSFET, when a temperature of the first MOSFET is not higher than a preset value, the operational amplifier outputs a low level signal, the electronic switch is turned off, when the temperature of the first MOSFET is higher than the preset value, the operational amplifier outputs a high level signal, the electronic switch is turned on.

2. The protection circuit of claim 1, wherein the third resistor is a negative temperature coefficient thermistor.

3. The protection circuit of claim 1, further comprising a conversion circuit, wherein the conversion circuit comprises a driving chip, a first inductor, first and second capacitors, fifth and sixth resistors, a second MOSFET, the first and second MOSFETs are n-channel MOSFETs, a power pin of the driving chip is connected to the second power input terminal, a first driving pin of the driving chip is connected to the gate of the first MOSFET, a drain of the first MOSFET is connected to a third power input terminal, a source of the first MOSFET is connected to a phase pin of the driving chip, the second power input terminal is grounded through the first capacitor, a second driving pin of the driving chip is connected to a gate of the second MOSFET, a drain of the second MOSFET is connected to the phase pin, a source of the second MOSFET is grounded through the first inductor, fifth and sixth resistors in that order, a node between the first inductor and the fifth resistor is grounded through the second capacitor, a node between the fifth resistor and the sixth resistor is connected to a feedback pin of the driving chip.

4. The protection circuit of claim 1, wherein the electronic switch is an n-channel MOSFET.
